(19) United States
(12) Patent Application Publication
(10) Pub. No.: US 2023/0085340 A1
(43) Pub. Date: Mar. 16, 2023

(54) LOWER CARBOHYDRATE SOUP PRODUCT AND PROCESS FOR PREPARING A LOWER CARBOHYDRATE SOUP PRODUCT

(71) Applicant: General Mills, Inc., Minneapolis, MN (US)

(72) Inventors: Coby Burckard, Minneapolis, MN (US); James Fudge, Champlin, MN (US); Doug L. Goedeken, Blaine, MN (US); Jeffrey T. Huber, Robbinsdale, MN (US); Erin James, Chaska, MN (US); Taylor C. Mulfinger, Shoreview, MN (US); Scott K. Whitman, New Hope, MN (US)

(73) Assignee: General Mills, Inc., Minneapolis, MN (US)

(21) Appl. No.: 17/475,483

(22) Filed: Sep. 15, 2021

(51) Int. Cl. A23L 23/10; A23L 29/269; A23L 5/10

(52) U.S. Cl. CPC A23L 23/10; A23L 29/27; A23L 5/13; A23V 2002/00

(57) ABSTRACT

A lower carbohydrate soup product is produced by preparing a mixture of soup ingredients, native xanthan gum, particulate xanthan gum and water to form a suspension in a high-speed mixer at a high sheer rate. The native xanthan gum and particulate xanthan gum cooperate to provide a viscosity necessary for successfully retorting a lower carbohydrate soup. The suspension is heated with steam injection until a viscosity sufficient to maintain the soup ingredients and particulate xanthan gum in a suspension. The suspension is then injected into a retort container and undergoes a retort process, thereby producing the lower carbohydrate soup product.

### FIELD OF THE INVENTION

The invention generally pertains the use of xanthan gum as a starch replacement in soup in order to reduce the carbohydrate and calorie content of the soup while maintaining the thickness and consistency of a starch-containing soup.

### BACKGROUND OF THE INVENTION

A variety of pre-cooked, shelf-stable foods are commercially available for consumer purchase and consumption. These food products are often made shelf stable by retorting the product during production, thereby sterilizing the product for longer shelf life. Generally, retorted food products are prepared by packing the ingredient items in a retort container and then thermally processing the container. The ingredients may be precooked prior to being added to the container or may cooked in the container during the process of retorting. In either case, the container can be sealed and thermally processed using a retort sterilization process. Retort sterilization typically involves heating the retort container and food ingredients contained in the container at a high temperature for a period of time sufficient to achieve commercial sterility of the food product. The process often occurs at high pressure and high temperature in a retort vessel during commercial production.

A large variety of retorted food products include high carbohydrate ingredients as thickeners, such as wheat flour or corn starch. For example, soups, pastas, and other products are typical commercially available retorted food products. While flour-based ingredients in retorted products continue to find widespread applicability, certain consumer groups focus on purchasing product having a lower carbohydrate and calorie content. There are challenges in cooking and baking using lower carbohydrate ingredients in place of the typical flours and starches. For example, traditional low carbohydrate alternatives to wheat or corn starch based products cannot survive the harsh conditions of retort.

Flour or starch based thickeners, hereinafter referred to as starch-containing thickeners, play an important role in retort products, such as soup, since contributes to the viscosity and texture of the final product and is critical such that the viscosity remains constant during and after storage of the retorted product. It has been challenging to find a lower carbohydrate replacement for starch-containing thickeners that does not break down after retort, thereby resulting in a very thin product.

Xanthan has a wide variety of industrial applications including use as a thickener, a stabilizing agent and a suspending agent, especially in foods. Xanthan is produced on an industrial scale by aerobic Submerged fermentation of a bacterium of the genus Xanth Omonas. The fermentation medium contains carbohydrate (such as Sugar), trace elements and other nutrients. Once fermentation is complete, the resulting fermentation broth is heat-treated. Following heat-treatment, the xanthan is recovered by alcohol precipitation. A well-recognized difficulty with xanthan gum has been its resistance to dispersibility and hydration. Typically, xanthan gum powder must be subjected to high agitation to get it to disperse and hydrate. Once dispersal and wetting are accomplished, the hydration of the gum is quite rapid, as evidenced by the development of viscosity.

Maintaining a proper viscosity throughout the stages of preparing a retort soup is very important for obtaining a desirable soup product. Although xanthan gum is capable of increasing viscosity, there is a need to further improve the viscosity enhancing properties of xanthan gum.

### SUMMARY OF THE INVENTION

The present invention is directed to a reduced or lower carbohydrate and calorie soup product and a process for preparing the soup product. The soup product is produced by preparing a mixture of soup ingredients, native xanthan gum, particulate xanthan gum and water to form a suspension in a high-speed mixer at a high sheer rate. The native xanthan gum and particulate xanthan gum cooperate to provide a viscosity necessary for successfully retorting a soup having a lower carbohydrate content than traditional retort soups. The suspension is heated to a temperature of about heating the suspension to a temperature of about 82 degrees Celsius in a kettle with steam injection until the viscosity is sufficient to maintain the soup ingredients and particulate xanthan gum in a suspension. The suspension is then injected into a retort container and undergoes a retort process, thereby producing the lower carbohydrate and calorie soup product.

It has been discovered that a combination of particulate xanthan and native xanthan provides the necessary viscosity at all steps of the retort process. Too much native xanthan can lead to a soup product that is too thick. Further, if only particulate xanthan is used, the viscosity of the starting product in the kettle cannot maintain a suspension state. More specifically, not only is the combination of particulate and native xanthan important, the actual ratio of native xanthan gum to particulate xanthan gum is important to achieve a viscosity necessary for effectively retorting the soup product. The ratio of native xanthan gum to particulate xanthan gum may be between 1:1 to 1:10. In some embodiments, the ratio is 15:85.

The soup ingredients may vary, and potentially includes a concentrated broth having a flavor of chicken, meat, fish, herb, fruit or vegetables. In other embodiments, the soup ingredients include dairy products for forming a cream-based product. Further, the soup ingredients may include gluten free or reduced carbohydrate pasta.

Additional objects, features and advantages of the invention will become more readily apparent from the following detailed description of preferred embodiments thereof.

### DETAILED DESCRIPTION OF EMBODIMENTS

in general, this disclosure is directed to techniques for producing lower calorie and carbohydrate soup products and the soup products so produced. When the other ingredients added to the container are also lower carbohydrate, such as low carbohydrate noodles, the entire retorted product be characterized and labeled as being a low carbohydrate and lower calorie product.

To produce a lower carbohydrate soup that survives a retort process, appropriate low carbohydrate ingredients may be selected and processed in such a way as to produce a resulting product that survives retort while also providing a texture and mouth feel similar to soups including starch-containing thickeners. Different factors that may influence the quality and efficacy of the lower carbohydrate soup include the characteristics of the lower carbohydrate ingredients used to produce the soup and the processing conditions under which the lower carbohydrate soup is produced. The disclosure relates to soups, including (but not limited to) chicken or poultry broth, chicken- or poultry-based soups (such as chicken noodle soup), tomato-based soups, cream-based soups and the like, in some embodiments the soups disclosed herein may include small quantities of starch-containing thickeners; however, in other embodiments the soups are devoid of starch-containing thickeners.

Xanthan gum is a suitable low carbohydrate, gluten free alternative to starch-containing thickeners in retort soups in accordance with the present invention. The term “xanthan” or “xanthan gum” as used herein means the extracellularly produced heteropolysaccharide made by a bacterium of the genus Xanthomonas. Examples of Xanthomonas species that may suitably be used to produce xanthan gum include Xanthomonas campestris, Xanthomonas begonias, Xanthomonas malvaceraum, Xanthomonas carotae, Xanthomonas incanae, Xanthomonas phaseoli, Xanthomonas vesicatoria, Xanthomonas papavericola, Xanthomonas translucens, Xanthomonas vesicatoria, and Xanthomonas hedrae.

The amount of xanthan added to the soup starting ingredients is critical for obtaining soups having acceptable properties. It has been discovered that using a combination of particulate and native xanthan gum produces the desired result. As will be recognized by those skilled in the art, native xanthan gum is comprised of a 1,4 linked D-glucose backbone with trisaccharide side chains on alternating anhydroglucose units. The side chains are comprised of a glucuronic acid residue between two mannose units. Approximately 30% of the terminal mannose molecules carry a pyruvic acid residue. Although the native xanthan gums provide some improvements over conventional starch-containing thickeners, there remain other problems with the resulting products. At low temperatures, native xanthan gum gets very viscous and following the retort process the xanthan gum and resulting product lose their viscosity. Further, when used alone as a thickener in place of starch-containing thickeners, native xanthan gum tends to impart an undesirable stringy, slimy texture to the product. Native xanthan gum is also typically resistant to dispersibility and hydration. Thus, native xanthan gum powder must be subjected to high agitation in order to properly disperse and hydrate. Then once the dispersal and wetting are accomplished the development of viscosity is quite rapid.

As described in U.S. Pat. No. 8,282,962, incorporated herein by reference, the particulate xanthan gum has improved water-dispersibility and viscosity enhancing properties when compared to native xanthan gum. Particulate xanthan gum provides significant benefits without resorting to chemical modification of the xanthan gum. The term “particulate” as used herein refers to particles of any porosity and or density. According to one embodiment, the present particulate xanthan gum is a free-flowing composition. The present particulate xanthan gum are typically homogeneous xanthan gum particles. The particles may exhibit a volume weighted average particle size in the range of 10-1000 μm. Particulate xanthan gum can be obtained by a process of extruding a mixture containing between 20 and 60 wt. % water and at least 10% of xanthan gum by weight of dry matter at a temperature of at least 60° C., drying the resulting extrudate, and converting the extrudate into a particulate composition prior, during or after the drying.

The viscosity of particulate xanthan is irreversibly enhanced by heating in a manner similar to corn starch; thus, particulate xanthan behaves in a similar manner as corn starch during the retort process. When compared to native xanthan, particulate xanthan combines easy water dispersibility with significantly improved viscosity enhancing properties. When an amount of particulate xanthan is used in combination with native xanthan, the initial viscosity is lower than if all native xanthan was employed.

However, particulate xanthan alone does not produce enough viscosity during the initial mixing step of the retort process of the present disclosure. Thus, a combination of particulate xanthan and native xanthan has been found to provide the necessary viscosity at all steps of the retort process. Too much native xanthan can lead to a soup product that is too thick. Further, if only particulate xanthan is used, the viscosity of the starting product in the kettle cannot maintain a suspension state. The ratio of native to particulate xanthan may be between 1:1 to 1:10, such as 1:3, 1:5, 3:8, etc. In a particularly preferred embodiment, the ratio of native to particulate xanthan is 15:85. Such ratios have may be used in chicken soups including broth, noodle and creamy soups.

The texture of viscous materials, such as soups, can be defined as the rate of the flow and it is measured with the Bostwick instrument. The measurement procedure includes pouring a sample in the Bostwick instrument. A gate is opened, and a timer is started as the sample runs along the axis. The further the sample runs along the slope, the less viscous is the material. The texture of the soup ingredients containing the xanthan gum is measured with a Bostwick instrument prior to the retort process. Additional measurements may be taken at different occasions to determine the parameters necessary for obtaining the desired thickness and flowability. For example, measurements may be taken before the retorting process, one day after retort, two weeks after retort, and at other times to give an overview of how the xanthan gum affected the soup properties over a longer time period.

The ingredients, including the native and particulate xanthan gum, are initially placed in a high-speed mixer and processed at a high sheer rate. The ingredients are then processed in a slurry kettle with steam injection at a temperature of about 82 degrees Celsius (180 F). It is important to maintain a certain viscosity in the kettle in order to retain the suspension of ingredients needed to dispense into the retort containers, i.e., cans.

The retortable container may be a bottle, a can, a jar, a bag, sealable tray, or other closable structure sufficient to withstand retort conditions. The retortable container can be manufactured from materials such a metal, glass, or plastic. For example, the retortable container may be a multi-layered laminated paper board container. As another example, the retortable container may be a rigid plastic tray, cup, jar, cart, bowl, or other shaped container. The soup ingredients may be formed into a slurry and then incorporated into the retort container through an open end of the vessel and the open end of the container subsequently closed to isolate the contents of the container from the ambient environment.

Other optional ingredients that may be included in the retort container with to form the soup product, such as an extruded gluten free pasta as taught in General Mills' U.S. patent application Ser. No. 16/998,961. One or more liquids or dissolvable extracts or concentrates may be added to the kettle for mixing with the suspension prior to adding to the retort container, such as a broth having a flavor of a meat, fish, herb, fruit or vegetables. Additional ingredients include protein sources (e.g., beef, pork, chicken, fish, fowl, tofu), vegetables (e.g., potatoes, carrots, beets, broccoli, corn), and seasoning (e.g., sugar, salt, pepper, garlic, sassafras, coriander, fennel, fenugreek, mustard, turmeric, cardamom, red pepper, cayenne pepper). The liquid component(s) of the product may form at least 25 volume percent of the content's product, such as at least 50 volume percent, or at least 60 volume percent. As a result, an extruded pasta or other ingredients may be partially or fully immersed or surrounded by the liquid in the container.

After incorporating the lower carbohydrate soup ingredients into the retortable container and closing the container, the container undergoes a mixing and retort process to form a retorted product. Initially, a package is erected, sealed at one end and placed in a carrier. The package is then transported to a first ingredient filler by the carrier. First ingredient filler dispenses a first ingredient into the package, i.e., the filler partially fills the package with the first ingredient. Next, the carrier transports the package to a second ingredient filler. A third ingredient filler and a fourth ingredient filler, which dispense a second ingredient, a third ingredient and a fourth ingredient, respectively, may also be employed. Afterwards, the package is transported back to sealer where the other end of the package is sealed and the package is removed from the carrier. The package is then transported to a mixer, which is configured to mix the ingredients within the package. This mixing is accomplished by transporting the sealed package along a plurality of rails and causing the sealed package to tip back and forth as the sealed package is transported. After mixing, the package is transported to a retort where the package is heated at a high temperature (typically between 110 and 135° C.) to sterilize the food product. However, in some embodiments, the mixing and retorting are conducted simultaneously. Further, the ingredient fillers may be separate or part of the same machine for incorporating the lower carbohydrate ingredients into a retort container, optionally with other ingredients, and closing the container to provide closed, retortable container.

Based on the above, it should be readily apparent that the present invention provides for systems and methods by which a lower carbohydrate soup product may be formed in a retort process using blends of native xanthan and particulate xanthan. Although described with reference to preferred embodiments, it should be readily understood that various changes or modifications could be made to the invention without departing from the spirit thereof. In general, the invention is only intended to be limited by the scope of the following claims.

1. A process for preparing a lower carbohydrate soup product comprising:
preparing a mixture of soup ingredients, native xanthan gum, particulate xanthan gum and water to form a suspension in a high-speed mixer at a high sheer rate;
injecting the suspension into a container and closing the container; and
retorting the suspension in the closed container, thereby producing the lower carbohydrate soup product.

2. The process of claim 1, further comprising: heating the mixture in a kettle with steam injection to a viscosity sufficient to maintain the soup ingredients and the particulate xanthan gum in the suspension.

3. The process of claim 1, wherein the native xanthan gum to the particulate xanthan gum is provided in a ratio of at least 1:5.

4. The process of claim 1, wherein the native xanthan gum to the particulate xanthan gum is provided in a ratio of about 15:85.

5. The process of claim 1, wherein injecting the suspension into the closed container comprises introducing the suspension through an opening in the container and subsequently closing the opening in the container.

6. The process of claim 1, wherein the soup ingredients include a concentrated broth having a flavor of chicken, meat, fish, herb, fruit or vegetables.

7. The process of claim 1, wherein the soup ingredients include dairy products forming a cream-based product.

8. The process of claim 1, wherein the soup product is devoid of starch-containing thickeners.

9. The process of claim 1, wherein the container is fabricated from a material selected from the group consisting of glass, metal, plastic, paper, and combinations thereof, and the container has a shape selected from the group consisting of a can, a pouch, a tray, a cup, and ajar.

10. The process of claim 1, wherein retorting the lower carbohydrate soup product in the closed container comprises heating the suspension in the closed container at a temperature greater than or equal to 125 degrees Celsius for a period of at least 10 minutes.

11. The process of claim 1, wherein the lower carbohydrate soup product has a gluten content of approximately 0 weight percent.

12. A lower carbohydrate soup product comprising:
a suspension of mixed soup ingredients, native xanthan gum and particulate xanthan gum; and
water, wherein the suspension is retorted in a container to form the lower carbohydrate soup product.

13. The product of claim 12, wherein ratio of native xanthan gum to particulate xanthan gum is at least 1:5.

14. The product of claim 12, wherein the ratio of native xanthan gum to particulate xanthan gum is about 15:85.

15. The product of claim 12, wherein the soup ingredients include a concentrated broth having a flavor of chicken, meat, fish, herb, fruit or vegetables.

16. The product of claim 12, wherein the soup ingredients include dairy products forming a cream-based product.

17. The product of claim 12, wherein the soup product is devoid of starch-containing thickeners.

18. The product of claim 12, wherein the lower carbohydrate soup product has a gluten content of approximately 0 weight percent.
